(19) United States
(12) Patent Application Publication
(10) Pub. No.: US 2007/0123172 A1
(43) Pub. Date: May 31, 2007

(54) Corruption detection of digital hardware configuration

(75) Inventors: Charbel Khawand, Miami, FL (US); Sankaran Srinivas, Parkland, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/291,625

(22) Filed: Nov. 30, 2005

(51) Int. Cl. H04B 17/00

(52) U.S. Cl. 455/67.7

(57) ABSTRACT

A wireless communication device (101) includes an application processor (345) that performs applications of the device and a baseband processor (327) that handles cellular communication. The baseband processor (327) monitors the application processor (345) for failures and, upon detecting a failure, reverts to a failsafe mode where a user of the wireless device can place calls through a voice recognition application running within the device and receive feedback from the device through a speaker (308) or a light (214).

### BACKGROUND OF THE INVENTION

1. Field of the Invention

This invention relates in general to single-core modem architecture in cellular communication devices and more particularly to a fail-safe mode of operation.

2. Description of the Related Art

Cellular devices, such as cellular phones and wireless PDA's, typically include modem circuitry for performing modem operations for cellular communications. These operations typically are classified by communications protocol layers. Examples of communication protocol layers include a physical layer, a data layer, and layers above the data layer such as (with the Open Systems Interconnect (OSI) model) a network layer, a transportation layer, a session layer, a presentation layer, and an application layer.

Cellular mobile devices typically perform the modem operations of these different layers with multiple processors, or multiple “cores.” For example, one processor may perform modem operations of the physical layer and/or data layer and another processor may perform modem operations of higher layers, such as running an operating system (OS). In one example, a cellular device uses a digital signal processor for the physical layer operations and a microcontroller unit processor for the higher layer operations.

An alternative type of architecture, referred to as a “single core” modem, removed the tightly coupled dependencies that once existed between an open OS and the protocol stack by separating the two. The single core architecture split between the two domains created what is called a Baseband processor (BP) and an Application processor (AP).

The AP is usually the interface provider for the keypad and display. When the AP becomes dysfunctional, both the keypad and display become unavailable for the user. This will prevent any transcoding with the base stations. However, there are circumstances when, if the AP enters the wrong state, it is desired to allow the user to continue on with some basic operations, such as placing a call to a 911 emergency service.

Accordingly, a need exists for allowing the BP to switch to a fail-safe mode of operation when it detects any AP failure.

### SUMMARY OF THE INVENTION

Briefly, in accordance with the present invention, disclosed is a wireless communication circuit arrangement and method that for allowing communication by an improperly operating wireless communication device. The present invention includes a first processor for processing applications, an audio input, and a second processor for performing modem operations, such as placing a call and terminating a call. The second processor detects an improper operation of the first processor and enters an emergency mode of operation. In the emergency mode, the device receives an audio input, interprets, with the second processor, the audio input, and executes at least one modem processing operation in accordance with the interpreted audio input.

The second processor is operable to detect that the first processor is operating improperly. The second processor then opens an audio channel and receives audio signals from the audio input, interprets the audio signals, and performs modem operations in accordance with the audio signals.

In one embodiment of the present invention, the second processor utilizes a voice recognition application executable by the second processor to interpret the audio signals that include verbal instructions from a user.

In another embodiment of the present invention, the voice recognition application utilizes a text-to-speech application, executable by the second processor, to convert output messages to audio signals and broadcasts the audio signals to a user.

In yet another embodiment of the present invention, the first processor is able to reset itself and/or the second processor.

In still another embodiment, the second processor is able to prevent the first processor from resetting the first processor and/or the second processor.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless system in accordance with an embodiment of the present invention;

FIG. 2 is a block diagram illustrating a wireless device in accordance with an embodiment of the present invention;

FIG. 3 is a schematic block diagram illustrating a wireless device in accordance with an embodiment of the present invention;

FIG. 4 is a diagram illustrating a stack of cellular communication protocol layers in accordance with an embodiment of the present invention;

FIG. 5 is a diagram illustrating a partitioning of program instructions in accordance with an embodiment of the present invention; and

FIG. 6 is a flow diagram illustrating the process of entering a wireless device fail-safe mode of operation in accordance with an embodiment of the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

System

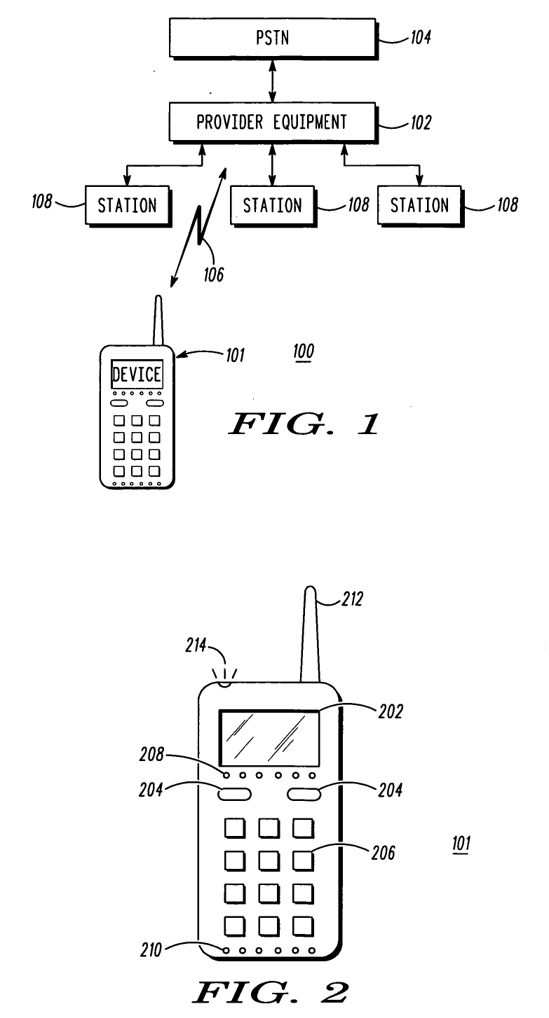

Described now is an exemplary hardware platform according to an exemplary embodiment of the present invention. FIG. 1 shows a block diagram of a radio communication system 100, in accordance with the present invention. The radio communication system 100 includes provider equipment 102, which is coupled to a public switched telephone network 104 and a wireless device 101. The provider equipment 102 includes a communication channel 106, and base stations 108. The provider equipment 102 interfaces with the public switched telephone network 104 to provide a gateway for managing and routing messages to and from particular wired and wireless devices. These messages may be obtained from a source outside the radio communication system via the public switched telephone network 104, or may be sourced from an internally serviced wireless device or other equipment.

The provider equipment 102 is able to provide direct communication between an originating wireless device and a target wireless device without accessing the public switched telephone network 104. The base stations 108 are coupled to the provider equipment 102 and are ordinarily geographically dispersed to service wireless devices in specific geographic regions. It is important to note, that wireless device 101, in another embodiment, is able to communicate with another wireless device without assistance of a communication network

Wireless Device

Referring now to FIG. 2, the wireless device 101 is shown. The specific wireless device 101 depicted in FIG. 1 is a cellular telephone, however the present invention is not so limited. Other examples of wireless devices are PDA's, wireless modems, SmartPhones, Laptops, Pagers, Two-way Radios, satellite communication devices, and others. The cellular device 101 includes a display 202 for viewing information and commands, command buttons 204 for controlling modes and commands of the device, buttons 206 for entering information and dialing numbers, an audio output 208, such as a speaker, for broadcasting voice and messaging information and audible alerts, an audio input 210, such as a microphone, for converting audible sounds to proportionate voltages, and an antenna 212 for transmitting and receiving wireless signals as per a cellular communications protocol. The cellular device 101 also has a light emitting device for communicating messages or states to a user.

The cellular device 101 interfaces with the provider equipment 102 via wireless communication link 106 established with the base stations 108. The cellular device 101 works in conjunction with the provider equipment 102 to provide a user with services such as telephone interconnect, short message service, dispatch or instant conferencing, circuit data, packet data, and combinations thereof, as well as other data services.

Single Core Modem

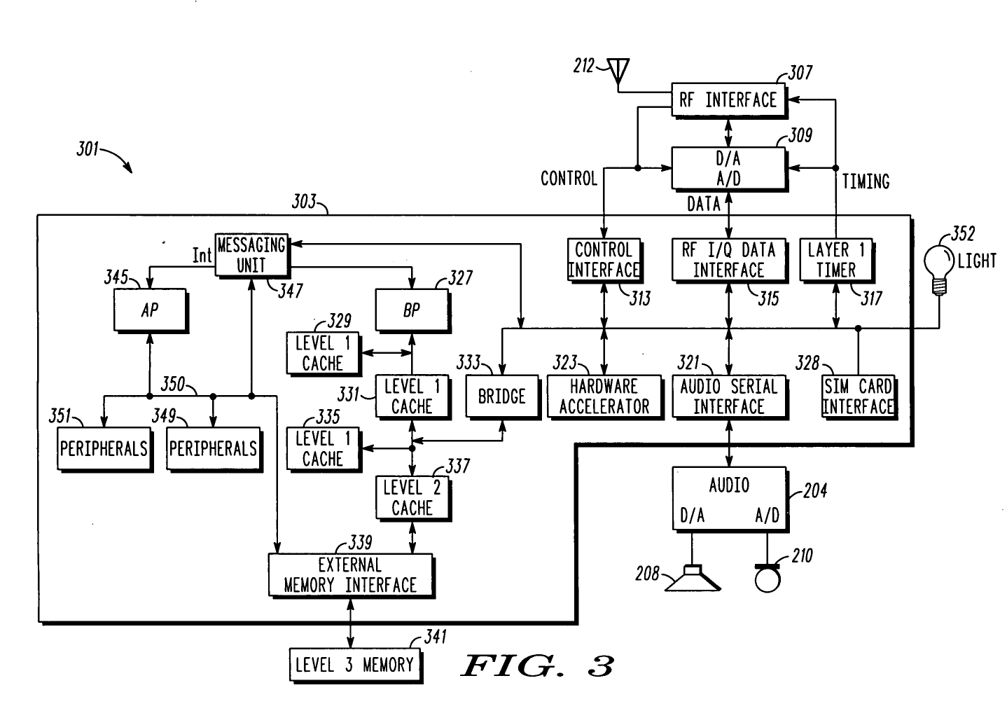

Referring now to FIG. 3, a schematic diagram of the cellular device 101, according to the present invention, is shown. In the embodiment shown, cellular device 101 includes an integrated circuit 303 having both an Application processor (AP) 345 and a Baseband processor (BP) 327. In the embodiment shown, AP 345 is utilized to perform applications of the cellular device 101 such as e.g. games, video, and word processing applications. The BP 327 is utilized in the cellular device 101 as a cellular modem processor. BP 327 is utilized to perform modem operations that enable the cellular device 101 to communicate encoded data (e.g. voice and/or information) over a cellular phone network as per a cellular communications protocol. As will be explained later, the BP 327 can perform processor modem operations of layer 1 (physical layer), layer 2 (data layer), and layer 3 of a cellular communication protocol (See FIG. 4).

Performing all or substantially all modem processor operations by a single processor can reduce system cost in that only a single processor is performing modem processor operations. The use of a single processor may also reduce system complexity in that only one processor instruction set need be utilized for modem functionality. Further, using one processor to perform all or substantially all of the modem processor operations may reduce or eliminate the amount of messaging between processors of a cellular device due to modem operations. Additionally, such a configuration may save power in that only one processor needs to be operable during modem operation. For example, if only a call function of the cellular device 101 is being utilized, the BP 327 can handle the modem processor operations while the AP 345 is not functioning, not functioning properly, or is placed in a low-power mode.

Cellular device 101 includes a control interface 313, an RF I/Q data interface 315, and a layer 1 (L1) timer 317 coupled to the BP bus 325, circuitry 309, and RF interface 307. In the embodiment shown, integrated circuit 303 also includes hardware accelerators 323, audio serial interface 321, and a subscriber identification module (SIM) card interface 327 coupled to BP bus 325. Antenna 212 is coupled to RF interface 307 which is coupled to analog to digital (A/D) and digital to analog (D/A) circuitry 309. Cellular device 101 includes audio circuitry 304, speaker 208, and microphone 210 for providing audio input and output to cellular device 101. In other embodiments, at least some of audio circuitry 304 may be implemented in integrated circuit 303.

In the embodiment of FIG. 3, BP 327 is operably coupled to BP bus 325 via level 1 cache 331 and bridge 333. Integrated circuit 303 also includes multiple hierarchal levels of memory with each level having a different manufacturing cost and access time. In one embodiment, level 1 memory 329 may include volatile and/or non volatile memory having a relatively fast deterministic access time, but at typically a relatively higher cost. In one embodiment, level 1 memory contains instructions and/or data for performing modem processor operations requiring fast deterministic access according to a cellular communications protocol. Level 1 cache 331 is utilized to decrease the average access time to instructions and data stored in level 2 memory 335 and level 3 memory 341.

In one embodiment, level 2 memory 335 may include volatile and/or non volatile memory having a relatively slower deterministic access time (compared to level 1 memory), but at typically a relatively lower cost. In one embodiment, level 2 memory 335 contains instructions and or data for performing modem processor operations having determinism and access time requirements that are less restrictive than those whose instructions and/or data are stored in level 1 memory 329. Level 2 cache 337 is utilized to decrease the average access time to level 3 memory 341.

In one embodiment, level 3 memory 341 may include volatile and/or non volatile memory having relatively the slowest deterministic access time (compared to level 1 and level 2 memory), but at typically the lowest cost. In one embodiment, level 3 memory 341 contains instructions and/or data for performing modem processor operations having the least restrictive determinism and access time requirements.

In other embodiments, cellular devices may have other memory configurations. In some embodiments, some modem operations (e.g. layer 1 operations or layer 2 operations) may be performed by a hardware accelerator 323. In addition, some layer 3 processor operations may be performed by AP 345. In other embodiments, the memories of a mobile device may contain instructions for the BP 327 to perform modem processor operations for more than one cellular communications protocol. In other embodiments, other types of processors (e.g. MCU processors) may be utilized to perform the modem processor operations. Furthermore, cellular devices of other embodiments may have other configurations.

In the embodiment of FIG. 3, the AP 345 is coupled to memory 351, peripherals 349, and external memory interface 339. AP 345 and BP 327 are each coupled to messaging unit 347 for exchanging messages there between. AP 345 and BP 327 also can exchange data in shared level 3 memory 341. In some embodiments, memory 341 may be located in integrated circuit 303.

The BP 327 handles cellular communication and communicates to the AP 345. In one embodiment, data is encoded by BP 327 as per a cellular communications protocol and provided via bridge 333, BP bus 325, RF I/Q data interface 315, and circuitry 309 to RF interface 307 to be transmitted over antenna 212. Encoded data is received by BP 327 from antenna 212 via RF interface 307, circuitry 309, RF I/Q data interface 315, bus 325, and bridge 333. Layer 1 timer 317 and control interface 313 provide the requisite timing and control information for the data to be communicated according to the cellular communications protocol.

Information to be transmitted as per cellular communications protocol may be provided to the BP 327 from the AP 345 for transmission. Furthermore, information received as per a cellular communication protocol may be provided from BP 327 to AP 345. In one embodiment, the information to be transmitted and the information received may be exchanged between the BP 327 and the AP 345 by one of the processors writing the information to a portion of shared memory 341 and the other processor accessing the information from the shared memory. A pointer may be exchanged between processors that points to the shared memory location of the data. In one embodiment, the cellular device 101 implements an interprocessor communication protocol for managing the communications between AP 345 and BP 327. The use and management of a shared memory is abstracted by the interprocessor communication protocol. Examples of interprocessor communication protocols may be found in U.S. patent application Ser. No. 10/610,746, entitled “An Interprocessor Communication Protocol,” filed Jul. 1, 2003 and U.S. patent application Ser. No. 10/643,327, entitled “Method and Apparatus for Providing Interprocessor Communications Using Shared Memory,” filed Aug. 19, 2003, both of which are hereby incorporated by reference in their entirety.

In some embodiments, other types of processors may be utilized in place of BP 327. Also in other embodiments, cellular device 101 may have other configurations. For example, other embodiments may not include SIM card 321 or hardware accelerators 323. Still in other embodiments, AP 345 and BP 327 may be implemented on separate integrated circuits.

FIG. 4 shows a stack 405 of cellular communication protocol layers. Operations of a cellular communication protocol layer are operations for performing the functions designated to the layer. For example, layer 1 operations may include (depending upon the particular cellular communications protocol) modulation operations, demodulation operations, interleaving operations, deinterleaving operations, channel encoding operations, channel decoding operations, channel equalization operations, synchronization operations, automatic gain control operations, and automatic frequency control operations.

Examples of layer 2 operations may include (depending upon the particular cellular communications protocol) medium access control (e.g. multiple access control) operations and logical link control (e.g. link access control) operations.

Examples of layer 3 operations may include (depending upon the particular cellular communications protocol) call control (CC) management operations, mobility management (MM) operations, subnet convergence protocol (SNDCP) operations, and radio resource (RR) management operations.

Specifics details of cellular communication protocol layers may be found in U.S. patent application Ser. No. 10/682,746, entitled “Cellular Modem Processing,” filed Oct. 9, 2003, which is hereby incorporated by reference in its entirety.

In one embodiment, the cellular device 101 is configured to communicate over a cellular communications network as per the Global System for Mobile communications (GSM). In other embodiments, cellular device 101 may be configured to communicate as per other cellular communications protocols such as the code division multiple access (CDMA) protocol, the Universal Mobile Telephone Service (UMTS) wide band CDMA (W-CDMA) protocol, the CDMA2000 protocol, the Time Division-Synchronous Code Division Multiple Access technology (TD-SCDMA) protocol, the Time Division Multiple Access (TDMA) protocol, the Integrated Digital Enhanced Network (iDEN) protocol, the Terrestrial Trunked Radio (TETRA) protocol, the General Packet Radio Services (GPRS) protocol, the Enhanced Data Rate for GSM Evolution (EDGE) protocol, the iDEN protocol, and the WiDEN protocol. Operations of each layer of stack 405 may vary with each of the different protocols.

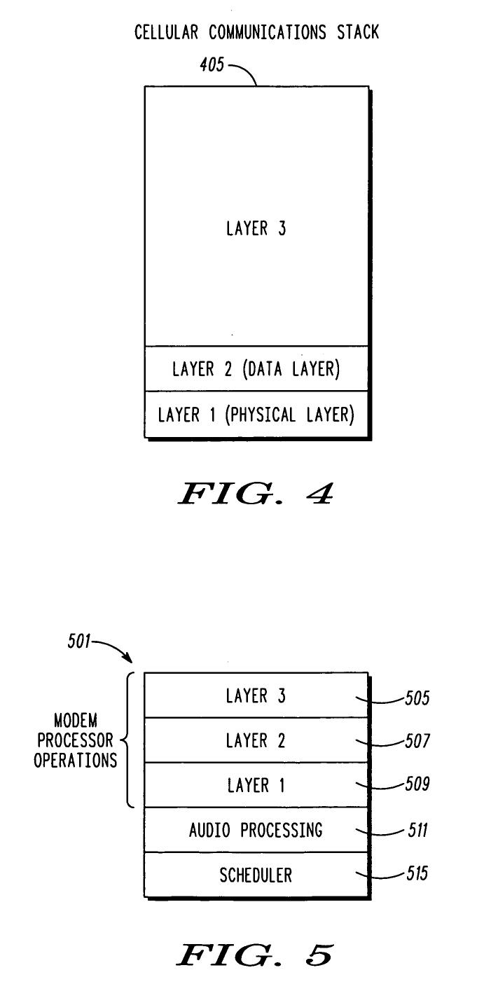

FIG. 5 shows one embodiment of a partitioning of program instructions for execution by BP 327 for performing processor operations. In the embodiment shown, the instructions whose partitioning is represented by block 501 are stored in a non volatile memory located on integrated circuit 303 (e.g. level 1 memory 329 and/or level 2 memory 335) and/or in off chip (level 3) memory 341. In some embodiments, at least some of the instructions are stored in a compressed format in a non volatile memory, wherein the instructions are decompressed and stored in volatile memory for execution by BP 327. In one embodiment, some instructions are stored in memory 329 and others are stored in memory 335.

In yet another embodiment, at least some of the BP 327 instructions are stored in memory 351 (in compressed or uncompressed format). AP 345 transfers the instructions from memory 351 to BP 327 through either the messaging unit 347 or level 3 memory 341 during system initialization. Upon receipt, BP 327 validates the authenticity of the memory contents and places the instructions in a memory (level 1 memory 329, level 2 memory 335, and/or level 3 memory 341).

In some embodiments, the instructions represented by block 501 are executed from a non volatile memory. In other embodiments, the instructions are executed from volatile memory. The instructions represented by block 501 are implemented using the instruction set for BP 327.

Block 501 represents instructions for performing modem processor operations. Modem processor operations are operations performed by a processor of a mobile device to facilitate communication as per a cellular communications protocol. Layer 3 instructions 505 are instructions for performing layer 3 processor operations. Layer 3 processor operations are processor operations performed by a processor of a mobile device to facilitate layer 3 operations of a cellular communications protocol. Examples of Layer 3 processor operations may include (depending upon the particular cellular communications protocol) call control (CC) management processor operations, mobility management (MM) processor operations, subnet convergence protocol (SNDCP) processor operations, and radio resource (RR) management processor operations.

Layer 2 instructions 507 are instructions for performing layer 2 processor operations. Layer 2 processor operations are processor operations performed by a processor of a mobile device to facilitate layer 2 operations of a cellular communications protocol. Examples of layer 2 processor operations may include (depending upon the particular cellular communications protocol) medium access control processor operations and logical link control processor operations.

Layer 1 instructions 509 are instructions for performing layer 1 processor operations. Layer 1 processor operations are operations performed by a processor of the mobile device to facilitate layer 1 operations of a cellular communications protocol. Examples of layer 1 processor operations may include modulation processor operations, demodulation processor operations, interleaving processor operations, deinterleaving processor operations, channel encoding processor operations, channel decoding processor operations, channel equalization processor operations, synchronization processor operations, automatic gain control processor operations, and automatic frequency control processor operations.

Block 501 also includes instructions 511 for performing audio processing processor operations and instructions 515 for performing scheduler processor operations. Some of these operations may be unrelated to operations of a cellular communications protocol.

In one embodiment, instructions for the BP 327 to perform the entire layer 3, layer 2, and layer 1 processor operations for cellular device 101 are stored in a memory (329, 335, and/or 341) of cellular device 101. For example, instructions for BP 327 to perform all of the processor operations for the modem operations described above with respect to a particular cellular communications protocol (e.g. GSM) are stored in a memory of cellular device 101. In another embodiment, instructions for BP 327 to perform all layer 2 processor operations and layer 1 processor operations and some of the layer 3 processor operations of a particular cellular communications protocol are stored in a memory of cellular device 101. Accordingly, the BP 327 alone is able to execute instructions to perform the processor operations for the cellular device 101 to communicate as per the particular cellular communications protocol.

The BP's ability to perform all modem processor operations can be critical in certain situations. For instance, there are times when the AP 345 ceases to perform properly. Examples of these times are when the AP 345 is locked up or lost, which can be the result of hardware or software failures. Because the AP 345 is able to run applications from various sources, the possibility of AP 345 failure is not insubstantial.

Separation of the processor functions is a significant advantage of the single-core architecture. In one embodiment, at least level 3 memory 341 is shared between the AP 345 and the BP 327. To protect cellular modem processor instructions from corruption by malicious instructions running on the AP 345, level 3 memory is subdivided into at least two regions. The first region is accessible only by the BP 327 and is used for holding instructions and data related to modem processor operations. This region is inaccessible by the AP 345, and is therefore secure from malicious instructions being executed by it. The second region is shared between the BP 327 and AP 345. Data and commands are passed between the processors in this region of the level 3 memory 341. Since both processors have access to this region, instructions and data critical to the cellular modem operations are not stored in this region. In other embodiments, other memory regions of mobile device 101 could be defined with other access protections or restrictions, depending on security requirements. Therefore, “untrusted” applications running on AP 345 would not have access to modem processor operations performed by the BP 327.

In one embodiment of the present invention, the BP 327 is able to automatically detect when the AP 345 is functioning improperly. The present invention gives a user of a cellular device 101 the ability to place at least emergency calls, using only the BP 327, when the AP 345 is no longer functioning properly. Many methods are contemplated and are known to those of skill in the art for performing a check on an Application processor to detect improper functionality. The failure detected can be hardware or software related and can be detected with either hardware or software methods. One exemplary method for detecting proper or improper functioning is to send a message from the BP 327, or some other system component, to the AP 345. If the message is not responded to by the AP 345 within a predetermined amount of time, the BP 327 is alerted that a problem may exist. Other adequate detection methods are known to those of skill in the art.

Referring back to FIG. 3, it can be seen that an audio path exists between the BP 327 and the microphone 210 and speaker 208. The BP 327 is linked to the microphone 210 and the speaker 208 through the level 1 cache 331, bridge 333, BP bus 325, audio serial interface 321, and finally to the audio circuitry 304.

In the event of an AP 345 failure, the BP 327 can no longer be told to start a phone call or accept one since neither the keypad 206 nor the display 202 are operational. The present invention allows the BP 327 to detect an AP 345 failure and revert to a Voice Recognition (VR) and Text to Speech (TTS) environment until the AP 345 is up and running again. The BP 327 opens the above-described audio path to the microphone 210 and/or the speaker 208. By also invoking the VR and TTS environment, the BP 327 can receive, interpret, and output audio signals in the form of verbal instruction to and from a user. Since the audio path remains operational under an AP 345 lock or reset, both VR and TTS from the BP 327 can be turned on. In this mode, the BP 327 routes its display information to the TTS framework and expects a reply from the user through its VR framework. The cellular device 101 can then accept instructions from a user, which may include “call 911,” “hang up,” “emergency,” or “call John Doe.” In which case, the BP 327 is operable to place a cellular telephone call to the proper destination or otherwise follow the voice commands issued by the user.

The BP 327 is also able to communicate messages to a user through the audio path or other pathway, which may include an illuminating visible alert 214, such as an LED. In one embodiment, the BP 327 can broadcast speech instructions or messages over the speaker 308.

In most systems, the AP 345 is able to reset itself and the BP 327. However, if the AP 345 is allowed to reset itself and/or the BP 327, the AP 345 may interrupt use of the cellular device 101. In the emergency call scenario given above, interruption of the BP 327 during an emergency call would be highly undesirable. Therefore, in one embodiment of the present invention, during periods when the BP 327 is operating as instructed by the user, the BP 327 is placed into a non-allowable reset state, which is determinable by the AP 345 and prevents the AP 345 from resetting itself and/or the BP 327. This state can be communicated to the AP 345 through, for example, the messaging unit 347, by holding a reset line low or high, depending on the particular configuration, by checking a memory location in shared memory, or transferred through a memory unit. In other embodiments, a logical AND gate is used to determine AP 345 resets, where the BP 327 does not allow the AND condition to be satisfied until the BP 327 emergency mode is no longer in use. Preventing the AP 345 from resetting and or the BP 327, until the BP 327 is ready, prevents the processors from conflicting with each other.

Therefore, in one embodiment, when the AP 345 finishes resetting, it requests the state of the BP 327. If BP 327 is in a fail-safe state, the AP 345 waits until the BP 327 is ready to resume normal operations with AP 345. If the BP 327 is in a non-fail safe state, the AP 345 is then allowed to reset the BP 345, if AP 345 deems it necessary.

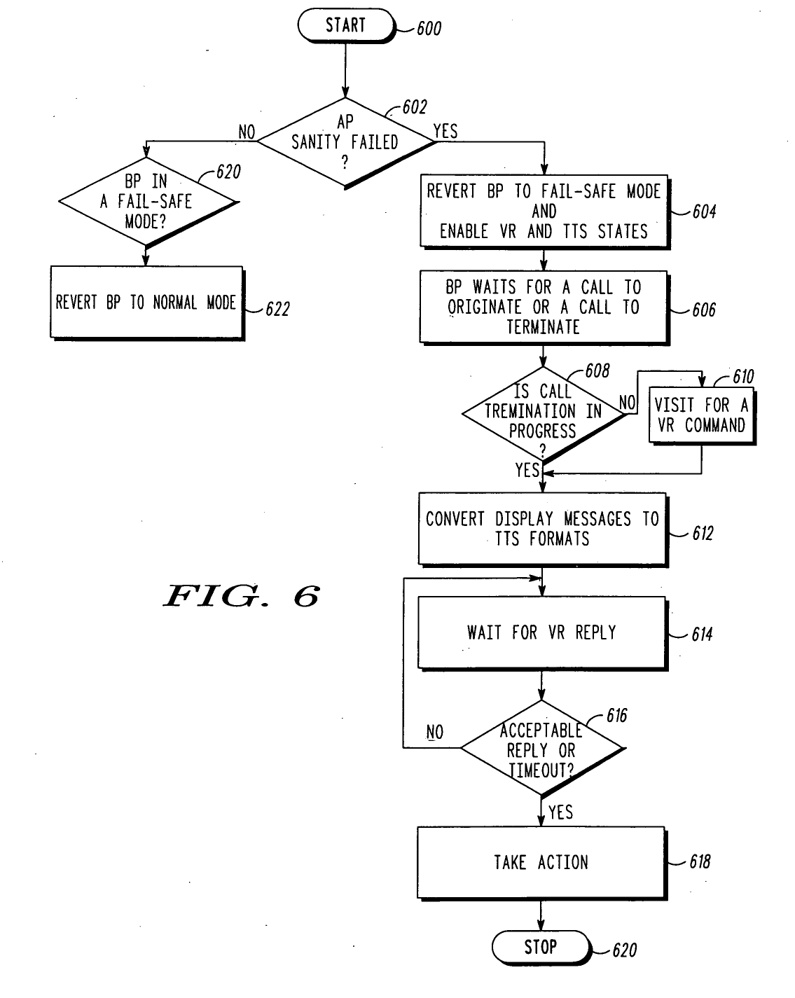

FIG. 6 is a flow diagram of the process of the present invention. The process begins at step 600 and moves directly to step 602 where the BP 327 performs a “sanity check” to determine if the AP 345 is not operating properly.

If the AP 345 is not operating properly, the flow moves to step 604, where the BP 327 reverts to a fail-safe mode. In the fail-safe mode, the VR and TTS states are enabled. The BP 327 then waits for a call to be originated or terminated in step 606. If one of the two events occurs, the process moves to step 608. In step 608 a check is made to determine if a call termination is currently in progress. If the call termination is not in progress, the process moves to step 610 and waits for a VR command. Once the VR command is received, or, alternatively, if the call termination was determined to be already in progress in step 608, the flow moves to step 612, where messages that would normally be text messages directed to the display 202 of the cellular device 101, are converted, via the TTS, to speech format and broadcast by the speaker 308. The process then waits, in step 614, for a VR input from the user.

If a reply is detected, the flow moves to step 616 where the reply is tested for acceptability. Acceptability may depend on recognition of the term or phrase spoken, volume, clarity, speed, or others. Alternatively, if, in step 614, a reply is not received, a timeout may occur where the system will stop waiting for a VR input. If the VR reply is deemed in step 616 to not be acceptable and a timeout has not been reached, the flow moves back up to step 614 and waits for another VR input. If, however, in step 616, a reply is deemed to be acceptable, the process moves to step 618 where an action is taken that corresponds to the VR input. If it is determined in step 616 that a timeout has been reached, the flow also moves to step 618 where an action is taken, such as resetting the AP 345. After an action has been taken in step 618, the process moves to step 620 and stops.

Alternatively, if, back at step 602, it is determined that the AP 345 is operating properly, the flow moves to step 620, where the BP 327 checks to see if it is in a fail-safe mode. If the BP 327 is in a fail-safe mode, it reverts to its normal mode in step 622.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A wireless communication circuit arrangement comprising:
a first processor for processing applications;
an audio input; and
a second processor for performing modem operations,
wherein the second processor detects that the first processor is operating improperly, receives audio signals from the audio input, interprets the audio signals, and performs modem operations in accordance with the audio signals.

2. The wireless communication circuit arrangement according to claim 1, further comprising:
a voice recognition application executable by the second processor, the voice recognition application for the interpreting the audio signals.

3. The wireless communication circuit arrangement according to claim 1, wherein the audio signals include verbal instructions from a user.

4. The wireless communication circuit arrangement according to claim 1, further comprising:
a text-to-speech application executable by the second processor, the text-to-speech application for converting output messages to audio signals; and
an audio output for broadcasting the audio signals.

5. The wireless communication circuit arrangement according to claim 1, wherein the first processor is able to reset at least one of the first processor and the second processor.

6. The wireless communication circuit arrangement according to claim 5, wherein the second processor is able to prevent the first processor from resetting at least one of the first processor and the second processor.

7. The wireless communication circuit arrangement according to claim 1, wherein the modem operation is at least one of originating a call and terminating a call.

8. The wireless communication circuit arrangement according to claim 1, wherein the second processor is able to generate at least one of an audio signal and a visible alert.

9. A method for allowing communication by an improperly operating wireless communication device, the method comprising:
detecting an improper operation of a first processor;
entering, with a second processor, an emergency mode;
receiving an audio input;
interpreting, with the second processor, the audio input; and
executing at least one modem processing operation in accordance with the interpreted audio input.

10. The method according to claim 9, wherein the modem processing operation is at least one of originating a call and terminating a call.

11. The method according to claim 9, further comprising:
preventing the first processor from resetting the second processor while the second processor is in a non-allowable reset state.

12. The method according to claim 9, further comprising:
generating at least one of an audio output signal and a visible output signal to communicate to a user.

13. The method according to claim 9, further comprising:
executing, with the second processor, a text-to-speech application to produce an audio output signal to communicate to a user.

14. The method according to claim 9, wherein a voice recognition application, executed by the second processor, interprets the audio input.

15. The method according to claim 9, further comprising:
resetting the first processor;
determining a state of the second processor and resetting the second processor if the second processor is in an allowable reset state after the first processor has been reset.

16. A computer program product for allowing communication by an improperly operating wireless communication device, the computer program product comprising:
a storage medium readable by a processing circuit and storing instructions for execution by the processing circuit for performing a method comprising:
detecting an improper operation of a first processor;
entering, with a second processor, an emergency mode;
receiving an audio input;
interpreting, with the second processor, the audio input; and
executing at least one modem processing operation in accordance with the interpreted audio input.

17. The computer program product according to claim 16, further comprising instructions for:
preventing the first processor from resetting the second processor while the second processor is in a non-allowable reset state.

18. The computer program product according to claim 16, further comprising instructions for:
generating at least one of an audio output signal and a visible output signal to communicate to a user.

19. The computer program product according to claim 16, further comprising instructions for:
executing, with the second processor, a text-to-speech application to produce an audio output signal to communicate to a user.

20. The computer program product according to claim 16, wherein a voice recognition application, executed by the second processor, interprets the audio input.
